(19) United States
(12) Patent Application Publication
(10) Pub. No.: US 2015/0002259 A1
(43) Pub. Date: Jan. 1, 2015

(54) STABILIZER FOR UNLOCKING AN ANTI-THEFT TAG

(71) Applicant: Alain Favier, Nogent Sur Marne (FR)

(72) Inventor: Alain Favier, Nogent Sur Marne (FR)

(73) Assignee: EXAQTWORLD, Joinville Le Pont (FR)

(21) Appl. No.: 14/365,131

(22) PCT Filed: Dec. 14, 2012
(86) PCT No.: PCT/FR2012/052949

§ 371 Date: Jun. 13, 2014

(30) Foreign Application Priority Data
Dec. 14, 2011 (FR) 1161652

(51) Int. Cl. E05B 73/00; G06K 7/10

(52) U.S. Cl. CPC E05B 73/0052; G06K 7/10009
USPC 340/5.2

(57) ABSTRACT

A device (1) for magnetically unlocking an assembly (10) for protection against theft of a packaged or unpackaged item includes a housing (3), containing at least one permanent magnet (4, 5, 6), and an unlocking surface (4a) for receiving a protective assembly (10) made up of two portions (14, 30) locked with each other to a packaged or unpackaged item so as to proceed to the magnetic unlocking of both portions (14, 30) of the protective assembly (10). The device (1) is characterized in that it includes, on the unlocking surface (4a), a mechanical stabilization element (50) for stabilizing the protective assembly according to a predetermined orientation. The predetermined orientation enables the magnetic field (B), generated by the at least one permanent magnet (4, 5, 6) in a manner perpendicular to the unlocking surface (4a), to magnetically unlock both portions (14, 30) of the protective assembly (10).

The invention relates to the magnetic unlocking of an anti-theft protection system, notably a system protecting against shoplifting of packaged or unpackaged articles.

To combat effectively shoplifting and more particularly shoplifting of certain products such as textile products (shirts, pullovers, underwear, trousers, lingerie, ties, socks, t-shirts, robes, overcoats, hats, shoes, polo shirts, skirts, etc.), traders use in a manner known in itself anti-theft tags or anti-theft protection systems (also known as security tags and “EAS tags”). These security tags trigger an anti-theft gate or an RFID-type surveillance system placed at the access points (entries/exits) of a point of sale such as a supermarket or hypermarket, a boutique, a specialist store, a duty free store, a department store, a museum, a video club, a pharmacy, and at the access points of any other store or entity selling or displaying self-service articles that are liable to be stolen or removed without authorization.

These tags are generally formed of two parts:
a body that contains a locking system and an active or passive member that triggers the detection antennas or gates commonly installed at the access points of the stores,
a pin that passes through the article to be protected (for example the fabric of a garment) or the cardboard or plastic of the packaging or blister packs.

In the points of sale the staff applies the tags to the articles to be protected.

When a protected article reaches the checkout, the two parts of the antitheft tag are separated from each other after unlocking the locking system.

Several locking system and several associated unlocking systems exist.

There exist in particular systems for locking the two parts of the security tag that have to be unlocked magnetically.

On reaching the checkout, magnetic unlocking is carried out by the staff of the store by placing the security tag on the unlocking surface of a magnetic unlocking device including one or more permanent magnets.

The magnetic field produced by the magnet or magnets unlocks the locking system of the security tag and therefore releases the two parts from each other as well as the article trapped between them.

However, the Applicant has noticed that the unlocking operation can be irksome: it is not unusual for the employee of the store to attempt to unlock the system more than once to arrive by trial and error at the correct orientation of the security tag relative to the unlocking surface and therefore relative to the direction of the magnetic field generated by the device.

In fact, the locking system can be unlocked only if it is positioned in a very precise geometrical orientation relative to the orientation of the magnetic field.

The unlocking operation is often rendered even more difficult by the fact that the security tag is fixed to a possibly bulky article to be protected (garment, etc.) and completely hide the unlocking surface, and even its near environment, from the sight of the employee.

Moreover, when equipped with active or passive theft detection means (for example LC, LCR, etc. type circuits) interacting with an exterior system (for example an anti-theft gate at the entry of a store), the security tags may be unbalanced. In particular, the presence in one of the two parts of the badge of a ferrite core and a coil wound around the core naturally causes a mechanical imbalance of the tag.

Accordingly, when the tag is placed on the unlocking surface, it is naturally inclined to the side and is therefore not positioned in accordance with the correct orientation that authorizes magnetic unlocking of the tag.

This imbalance is aggravated if the shape of the part of the security tag that is placed on the unlocking surface is convex and smooth (of rounded general shape, but not necessarily spherical or hemispherical).

Such a shape is therefore unstable because it has no edges able to halt the tilting or rolling movement of this part of the badge on the plane horizontal unlocking surface.

The employee therefore has to straighten up the tag in order to place it in the correct orientation, which takes them time.

Moreover, if the article to which the tag is attached conceals the unlocking surface, the operation is rendered even longer and more difficult.

Moreover, the magnets used for unlocking are increasingly powerful. The intensity of the field may be as high as 16000 or 17000 Gauss.

It follows that the employee of the store finds it more and more difficult to straighten up the security tag exposed to a magnetic field of such intensity and thus to proceed to unlock (open) it.

This operation can also have unwanted consequences for the article to be protected such as a garment (textile, etc.) because the employee must often fight against the magnetic attraction and therefore exert a force on the tag and on the garment when straightening up the tag.

The garment may therefore be damaged.

Certain types of locking and unlocking systems use magnetic balls and a magnetic spring pushing on the balls in one direction so that they trap between them, inside one part of the tag, the spike of the other part of the tag. Unlocking is obtained by attracting the balls and the spring in opposite directions, aligning the axis of the spring and that of the magnetic field.

Now, with increasingly powerful magnets the security tag is attracted onto and held with great force against the unlocking surface. Because of the high intensity of the force of attraction the spring is held in an inclined geometrical orientation relative to the surface and not perpendicular thereto. Its upper part located under the balls then tends to be deformed transversely.

Accordingly, when the employee straightens up the badge, the deformed spring is no longer rectilinear and is therefore no longer aligned with the axis of the magnetic field, thereby making unlocking very difficult if not impossible.

In view of the foregoing, it would therefore be desirable to facilitate the operation of magnetic unlocking of a security tag.

In a first aspect, the present invention concerns a magnetic unlocking system, characterized in that it includes:
a system protecting against the theft of a packaged or unpackaged article, the system comprising two parts locked to each other by axial insertion of a spike of a first part in an orifice of a second part that includes means for locking the inserted spike, the second part having at least one opening separate from the orifice for receiving the spike of the first part and retaining it there so as to be able to raise the two parts of the system holding only the first part,
a device for magnetically unlocking the protection system that includes:
   a casing enclosing at least one permanent magnet,
   an unlocking surface provided with means for reception and mechanical stabilization of the system, said means being designed to receive at least one part of the system and to stabilize it in a predetermined orientation, said predetermined orientation enabling the magnetic field that is generated by said at least one permanent magnet, perpendicularly to the unlocking surface, to unlock magnetically the two parts of the protection system.

The receiving and mechanical stabilization means systematically confer on the protection system (security tag) received thereby a predetermined geometrical orientation (spatial orientation) which is that allowing the unlocking of the two parts of this system. The article or its packaging trapped between the two parts is then released.

The unlocking of the protection system is therefore greatly facilitated because it suffices to position this system on the stabilization means to be able to separate the two parts automatically and release the article.

This operation proves faster than in the prior art.

Moreover, the unlocking operation is also simplified even if the employee of the store present at the checkout cannot see the unlocking surface and the associated stabilization means because of the presence of the article (for example a garment) to which the protection system is fixed. In fact, it suffices for the employee to bring the protection system above the unlocking surface equipped with the receiving and stabilization means for this system to be attracted by the magnet or magnets toward the receiving and stabilization means and to lodge there automatically, without having to proceed by trial and error with no visibility. By being positioned in this way in the receiving and stabilization means, the protection system automatically and assuredly assumes the predetermined spatial orientation allowing its opening.

It will be noted that the receiving and stabilization means are designed to make the extraction of the second part of the protection system difficult once unlocking has occurred and the first part has been removed.

The configuration of the second part of the protection system (opening(s) separate from the orifice for axial insertion of the spike) itself bears the means that enable extraction of the second part of the receiving and stabilization means when, following unlocking, the first part has been removed and the article detached. These means are effective when the magnetic field is powerful.

The unlocking device therefore does not include any complicated (motorized, etc.) mechanism for extracting the second part as is the case in the document U.S. Pat. No. 5,063,047 with an axially mobile part that brings about lifting on command.

In accordance with one possible feature, the receiving and mechanical stabilization means define a central housing to receive at least one part of the protection system, the shape of said housing being substantially complementary to that of said at least one part of the protection system.

The housing receiving at least one part of the protection system confers on the latter a spatial orientation suited to the magnetic unlocking of its two parts.

The shape of the housing is substantially complementary to that of said at least one part of the protection system in order for the latter to fit in the housing as precisely as possible. Housed in this way, the part (second part) does not project out of the housing, which makes gripping it impossible. Extracting this part is then made very difficult.

It will be noted that the housing ideally has the complementary shape so that said part espouses the internal shape of the housing.

However, in some cases the shape of the housing is not strictly complementary to that of said part, for example for manufacturing reasons.

Nevertheless, to provide the stabilization function the shape of the housing is complementary to that of said part of the protection system over the great majority of its concave internal surface.

This housing has a funnel or cup shape, for example.

In accordance with one possible feature, the housing has a bottom facing the unlocking surface and an opening on the side opposite the bottom, the bottom and the opening being disposed opposite each other in an axial direction perpendicular to the magnetic unlocking surface.

It will be noted that the shape of the housing is complementary to that of said at least one part of the protection system over the majority or its internal surface, notably in the vicinity in the opening of the housing and in the direction of the bottom.

The bottom and the opening of the housing therefore being oriented axially, said at least one part of the protection system inserted in the housing adopts the spatial orientation required for unlocking.

In accordance with one possible feature, the receiving and stabilization means include at least one annular wall at least partly delimiting (surrounding) the central housing.

In accordance with another possible feature, notches are produced in said at least one annular wall so as to interrupt the latter locally or to reduce locally the axial dimension referred to as the height of said at least one annular wall, the axial dimension being perpendicular to the horizontal magnetic unlocking surface. It will be noted that the wall therefore adopts an undulating shape. This enables gripping of the protection system or one part (second part) thereof to be facilitated once it has been placed in the housing.

A notch enables the part remaining in the housing to be tilted to one side by a finger or the other part (first part with the spike) of the system.

In other words, the notches enable access to be provided to a portion of the part that remains in the housing and therefore make it possible to facilitate its extraction.

In accordance with one possible feature, two diametrically opposite notches are produced in said at least one annular wall. Such an arrangement enables positioning two fingers of the same hand to extract the part of the protection system that has remained in the housing.

In accordance with another possible feature, the receiving and stabilization means include an uninterrupted annular wall surrounding the central housing.

Accordingly, said at least one part of the protection system positioned in the housing proves more difficult to extract if the annular wall surrounding the housing is continuous.

In accordance with one possible feature, said at least one annular wall has an axial dimension referred to as its height that extends in an axial direction perpendicular to the horizontal magnetic unlocking surface.

In accordance with another possible feature, said height is substantially equal to the dimension or height of the part of the protection system that is intended to be inserted in the central housing.

If the annular wall surrounding the housing is uninterrupted and its height is that of said part filling the housing, gripping this part after unlocking proves very difficult.

In accordance with another possible feature, said annular wall has at its upper free edge a peripheral rim forming an internal radial step with respect to said annular wall in order to raise it.

In accordance with another possible feature, said annular wall having the raising peripheral rim has an axial dimension referred to as its height that extends in an axial direction perpendicular to the horizontal unlocking surface, thereby increasing the height of the housing.

In accordance with another possible feature, said height is substantially equal to the dimension or height of the whole protection system that is intended to be inserted in the central housing.

In accordance with another possible feature, said at least one annular wall has at its upper free edge a protection ring mounted on elastic means and forming a peripheral rim axially mobile between a first extended high position raising the fixed annular wall (and increasing the height of the housing) and a second retracted low position relative to the fixed annular wall, the elastic means exerting a continuous axial force on the protection ring that tends to hold it in the extended high position.

In accordance with another possible feature, said annular wall having the protection ring has an axial dimension referred to as its height that extends in an axial direction perpendicular to the horizontal unlocking surface.

In accordance with another possible feature, said height is substantially equal to the dimension or height of the whole protection system that is intended to be inserted in the housing.

If the annular wall surrounding the housing is uninterrupted and is raised, either by a peripheral raising edge or by a protection ring as briefly described above, it is very difficult for a user to extract said at least one part of the protection system that remains in the housing after unlocking the two parts of said system. The presence of one or more openings separate from the orifice in the second part remaining in the housing enables extraction thereof thanks to the intervention of the first part.

In accordance with one possible feature, the central housing has a bottom that is pierced and opens directly onto the unlocking surface. This arrangement favors the placement of said at least one part of the protection system as close as possible to said at least one permanent magnet.

This arrangement therefore favors the efficacy of the magnetic unlocking.

In accordance with one possible feature, the receiving and mechanical stabilization means are mounted on the unlocking surface in a removable or fixed manner.

Removable receiving and stabilization means make it possible to equip the unlocking device with several types of stabilization means each adapted to a protection system with a different configuration (interchangeability of means).

In accordance with another possible feature, the receiving and stabilization means are formed in one part, thereby facilitating the construction of the stabilizer and its placement.

In accordance with another possible feature, the protection system includes a system for locking the two parts including the locking means that are unlockable magnetically by movement of said means along a so-called unlocking axis by the action of a magnetic field with the same axis.

In accordance with one possible feature, the receiving and mechanical stabilization means are configured to orient the unlocking axis of the locking means in a direction parallel to the axis of the magnetic field generated by said at least one permanent magnet of the magnetic unlocking device.

The orientation conferred by the housing of the receiving and stabilization means to said at least one part of the protection system received in the housing makes it possible to orient the unlocking axis in a manner favorable to unlocking the locking means of the protection system.

In accordance with one possible feature, the locking means of the second part include one or more magnetic material elements cooperating with the inserted spike in order to prevent the axial withdrawal thereof.

In accordance with another possible feature, the magnetic material elements are balls surrounding the spike and disposed in the same plane inside a funnel-shaped part that extends along a so-called funnel axis, the balls being mounted on a magnetic material elastic means that tend to push said balls toward the narrowest part of the funnel-shaped part along said funnel axis.

The funnel axis and the unlocking axis are identical and, by positioning the funnel axis parallel to the axis of the magnetic field generated by said at least one permanent magnet of the unlocking device, the balls are attracted by the magnetic field and are extracted from the narrowest funnel-shaped part, thereby releasing the spike.

In this way the two parts of the protection system are separated from each other.

In accordance with one possible feature, the second part includes a first portion including the orifice for the axial insertion of the spike of the first part in said second part (body) and a second portion in which the inserted spike extends at least in part and is locked.

In accordance with one possible feature, the first portion includes said at least one opening separate from the orifice for inserting the spike of the first part in a hollow portion of the second portion, the hollow portion being designed to receive the spike and to retain it in an unlocked so-called assembly position of the two parts of the protection system, this position being such that a user is able to separate the two parts from each other without tools (by pulling the two parts simultaneously in opposite directions with the fingers).

This opening (or these openings) is (or are) used for example to withdraw the second part of the protection system remaining in the housing after separation of the two parts of the protection system. To this end, the spike of the first part is introduced into the opening or into one of the openings until the two parts are fixed temporarily and the first part is then raised, therefore drawing with it the second part.

This is particularly useful if the uninterrupted annular wall has a height equal to or greater than that of the part of the protection system wedged in the housing.

This is the case in particular if the annular wall is raised by a peripheral rim or a protection ring.

In accordance with one possible feature, the external surface of said at least one part of the protection system is convex and smooth.

As already mentioned, such a feature of the external surface amplifies the instability of the protection system on an unlocking surface that is plane or that is not adapted to the shape of this system.

The instability is generated by the asymmetrical presence of the anti-theft members housed in at least one of the two parts of the system.

The use of a powerful magnetic field does not facilitate the straightening up and retention in a vertical position of the protection system with a view to unlocking it.

The receiving and mechanical stabilization means in accordance with the invention as described in various forms hereinabove provide a solution to the new specific problem explained above.

In accordance with another possible feature, the central housing has a cup general shape having an internal surface that is smooth.

Such a shape makes it possible to espouse the convex and smooth shape of the external surface of said at least one part (for example second part) of the protection system and therefore to stabilize it by conferring on it the required geometrical orientation.

In another aspect, the invention provides a method of magnetically unlocking a system for protecting a packaged or unpackaged article against theft, characterized in that the protection system comprises two parts locked to each other by axial insertion of a spike of a first part in an orifice of a second part that includes means for locking the inserted spike, the second part including at least one opening separate from the orifice for receiving the spike of the first part and retaining it there, the method including the following steps:
positioning at least one part of the protection system attached to the article on an unlocking surface of a magnetic unlocking device that includes at least one permanent magnet,
mechanical stabilization of said at least part of the system in a predetermined orientation, said predetermined orientation enabling the magnetic field that is generated by said at least one permanent magnet, perpendicularly to the unlocking surface, to unlock magnetically the two parts of the protection system,
magnetic unlocking of the protection system,
separation of the two parts of the protection system by raising the first part, the second part remaining in a mechanically stabilized position,
removing the article.

This method has the same advantages as those referred to above in relation to the system and will therefore not be repeated. According to other possible features taken separately or in combination with each other:
the second part is retained in a mechanically stabilized position in a housing the shape of which is substantially complementary to the exterior shape of said second part, thereby rendering its extraction difficult;
the method further includes the following steps:
   axial insertion of the spike of the first part in said at least one opening of the mechanically stabilized second part until an axial position of the inserted spike is reached in which the two parts are assembled mechanically to each other in an unlocked manner,
   grasping the first part and raising it, therefore entraining in this movement the second part assembled with the first part; thus extraction is effected thanks entirely to the configuration of the two parts of the protection system, with no need to move the second part by means of a heavy and complex mechanism that makes the magnetic unlocking device (decoupler) considerably more complicated; the stabilization means can be made in one piece;
when the spike of the first part is inserted axially in said at least one opening, the first and second parts are offset transversely relative to each other with respect to a so-called axial locking position in which the two parts are axially aligned with each other when the spike is inserted axially in the orifice; the part (first part) offset in this way and placed outside the stabilization means (e.g. housing) constitutes a manual grip that facilitates holding it and therefore lifting it.

In accordance with another additional feature, the invention provides a device including a casing containing at least one permanent magnet and an unlocking surface intended to receive an anti-theft protection system in order to proceed to the magnetic unlocking of said protection system, characterized in that the device includes on the unlocking surface mechanical stabilization means intended to stabilize the protection assembly in a predetermined orientation, said predetermined orientation enabling the magnetic field that is generated by said at least one permanent magnet, perpendicularly to the unlocking surface, to unlock magnetically the protection system, the stabilization means including at least one annular wall that at least partly delimits a central housing intended to receive at least one part of the protection system, notches being produced in said at least one annular wall so as to interrupt it locally or to reduce locally the axial dimension, referred to as the height, of said at least one annular wall, the axial dimension being perpendicular to the magnetic unlocking surface. This device has the same advantages as referred to above, notably in relation to the system, and that will therefore not be repeated.

In accordance with other possible features taken separately or in combination with each other:
the central housing has a bottom that is pierced and opens directly onto the horizontal magnetic unlocking surface;
the central housing has a cup general shape having an internal surface that is smooth;
the stabilization means are formed in one part;
the stabilization part is mounted on the magnetic unlocking surface in removable or fixed manner.

In accordance with a further additional feature, the invention provides a device including a casing containing at least one permanent magnet and an unlocking surface intended to receive an anti-theft protection system in order to proceed to the magnetic unlocking of said protection system, characterized in that the device includes on the unlocking surface mechanical stabilization means intended to stabilize the protection system in a predetermined orientation, said predetermined orientation enabling the magnetic field that is generated by said at least one permanent magnet, perpendicularly to the horizontal unlocking surface, to unlock magnetically the protection system, the stabilization means being formed of a part including at least one uninterrupted annular wall that delimits a central housing intended to receive at least part of the protection system. This device has the same advantages as referred to above, notably in relation to the system, and that will therefore not be repeated.

In accordance with other possible features taken separately or in combination with each other:
said at least one uninterrupted annular wall has at its upper free edge a peripheral rim forming an internal radial step with respect to said at least one annular wall in order to raise it;
said at least one uninterrupted annular wall having the raising peripheral edge has an axial dimension referred to as its height that extends in an axial direction perpendicular to the magnetic unlocking surface;
said at least one uninterrupted annular wall has at its upper free edge a protection ring mounted on elastic means and forming a peripheral rim mobile axially between a first extended high position raising said at least one fixed annular wall and a second retracted low position relative to said at least one fixed annular wall, the elastic means exerting a permanent axial force on the protection ring that tends to retain it in the extended high position;
said at least one uninterrupted annular wall provided with the protection ring has an axial dimension referred to as its height that extends in an axial direction perpendicular to the magnetic unlocking surface;
the central housing has a bottom that is pierced and opens directly onto the magnetic unlocking surface;
the central housing has a cup general shape having an internal surface that is smooth;
the stabilization part is mounted on the magnetic unlocking surface in removable or fixed manner.

Other features and advantages will become apparent in the course of the following description given by way of nonlimiting example only and with reference to the appended drawings, in which:

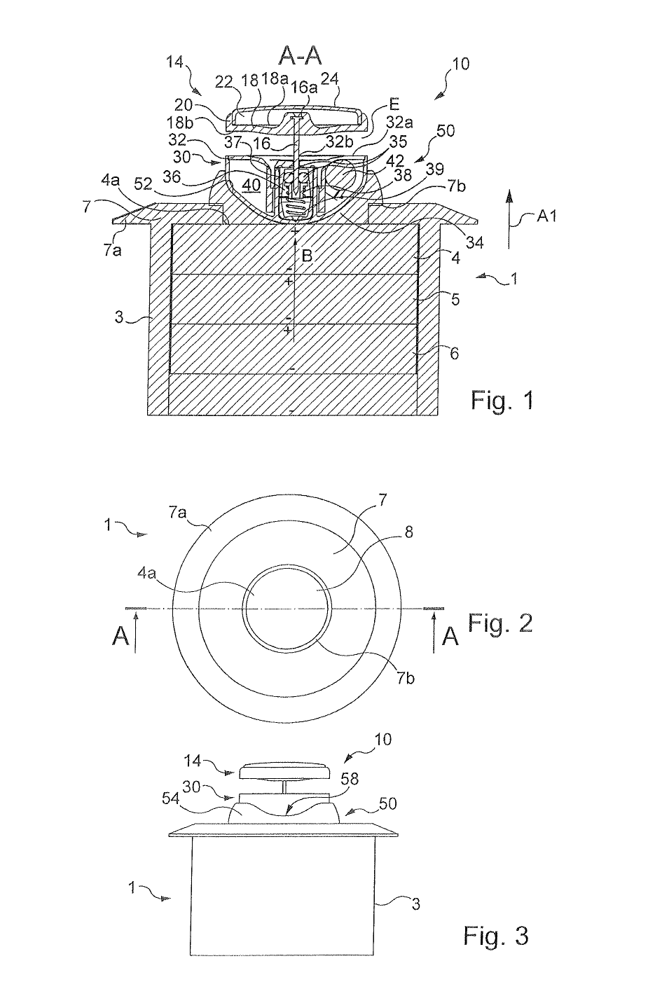

FIGS. 1 to 3 and 5 show a first embodiment of a system in accordance with the invention including a magnetic unlocking device equipped with mechanical stabilization means;

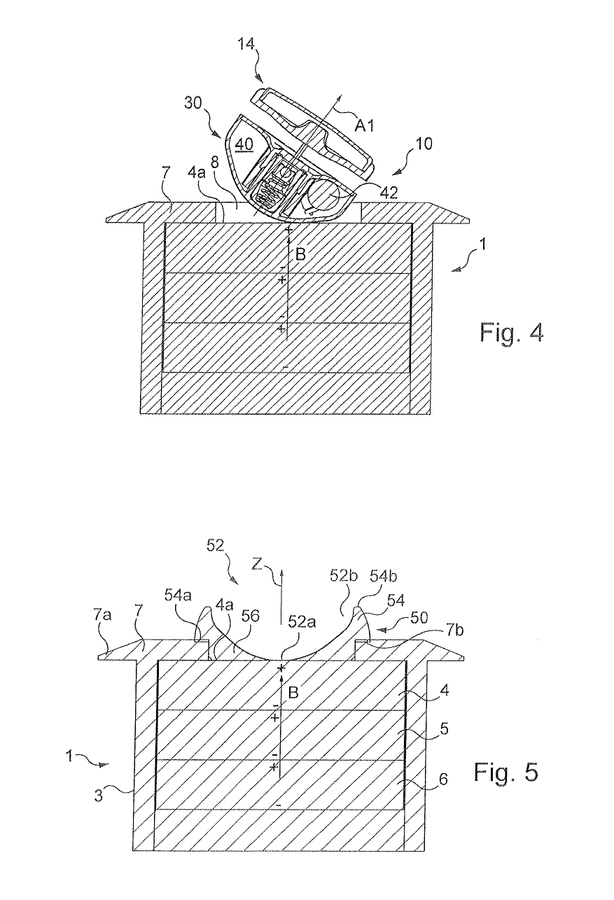

FIG. 4 shows a system including a magnetic unlocking device with no mechanical stabilization means;

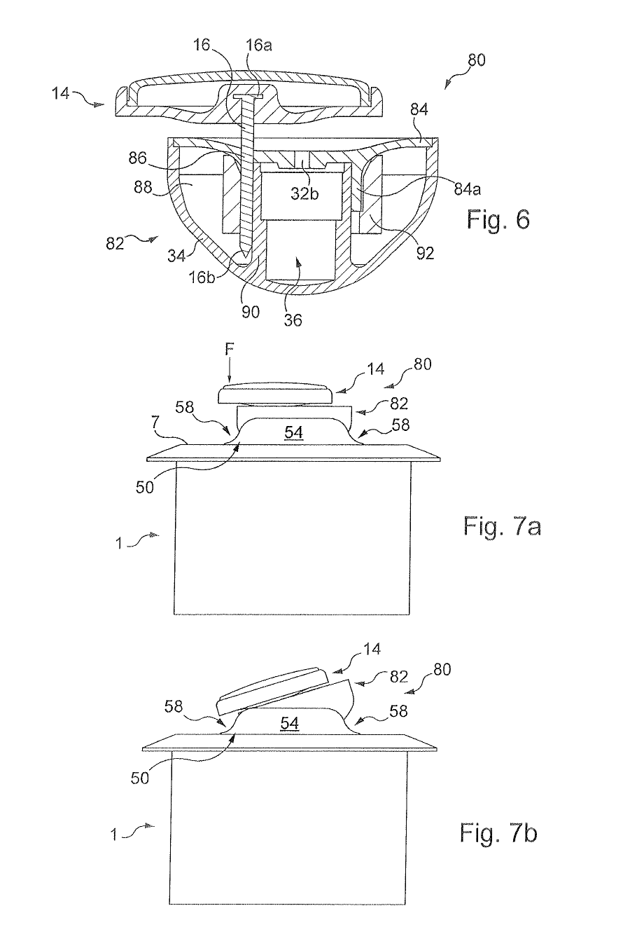

FIG. 6 shows one embodiment of a protection system or security tag in accordance with the invention;

FIGS. 7a and 7b show the placement of the system from FIG. 6 on the unlocking device of the first embodiment;

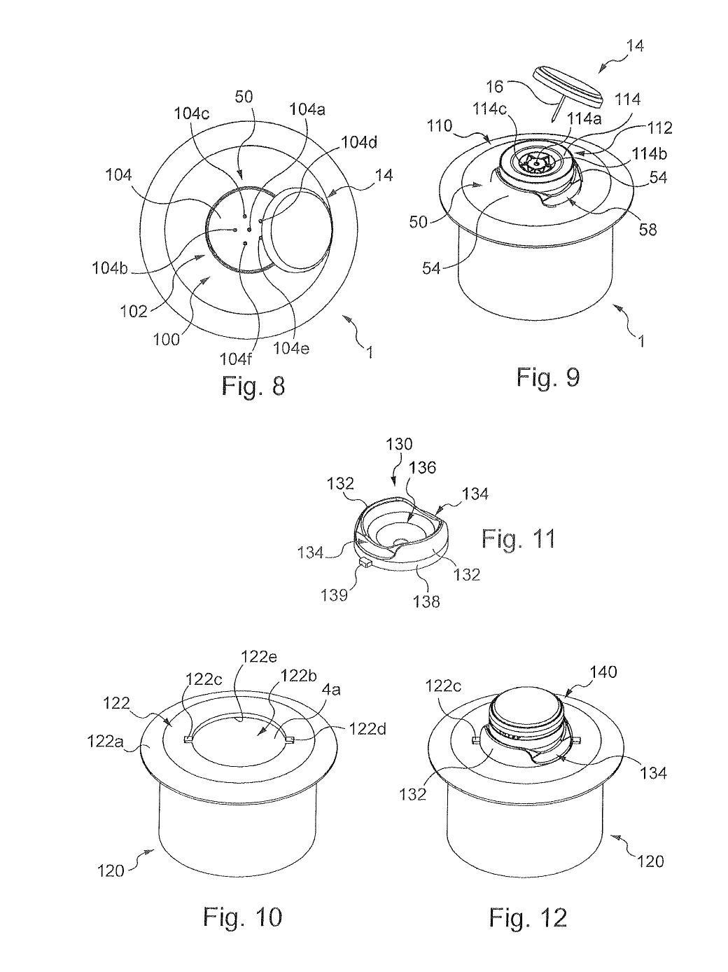

FIGS. 8 and 9 show the placement of two variants of the protection system from FIG. 6 on the unlocking device of the first embodiment;

FIGS. 10 and 11 respectively show a magnetic unlocking device and a mechanical stabilization means in accordance with a second embodiment;

FIG. 12 shows the placement of a protection system on the device from FIG. 10 equipped with the means from FIG. 11;

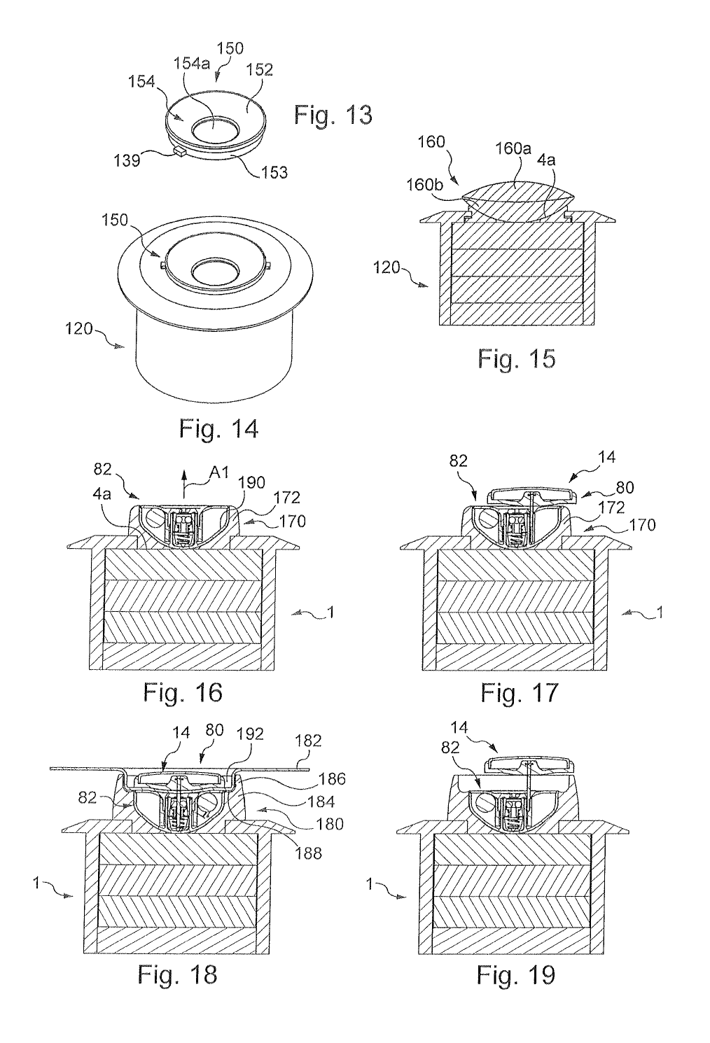

FIGS. 13 and 14 respectively show a variant embodiment of the mechanical stabilization means from FIG. 11 and the device from FIG. 10 equipped with such means;

FIG. 15 shows the placement of a protection system on the device from FIG. 14;

FIGS. 16 and 17 show a system including an unlocking device provided with mechanical stabilization means in accordance with a third embodiment highlighting one part of a protection system enclosed in its housing (FIG. 16) and the use of the other part of the system to extract it from this housing (FIG. 17);

FIG. 18 shows a system including an unlocking device equipped with mechanical stabilization means in accordance with a fourth embodiment and highlighting a protection system attached to an article to be protected;

FIG. 19 shows the use of one of the parts of this system to extract the other part of said system wedged in the bottom of the housing of the stabilization means;

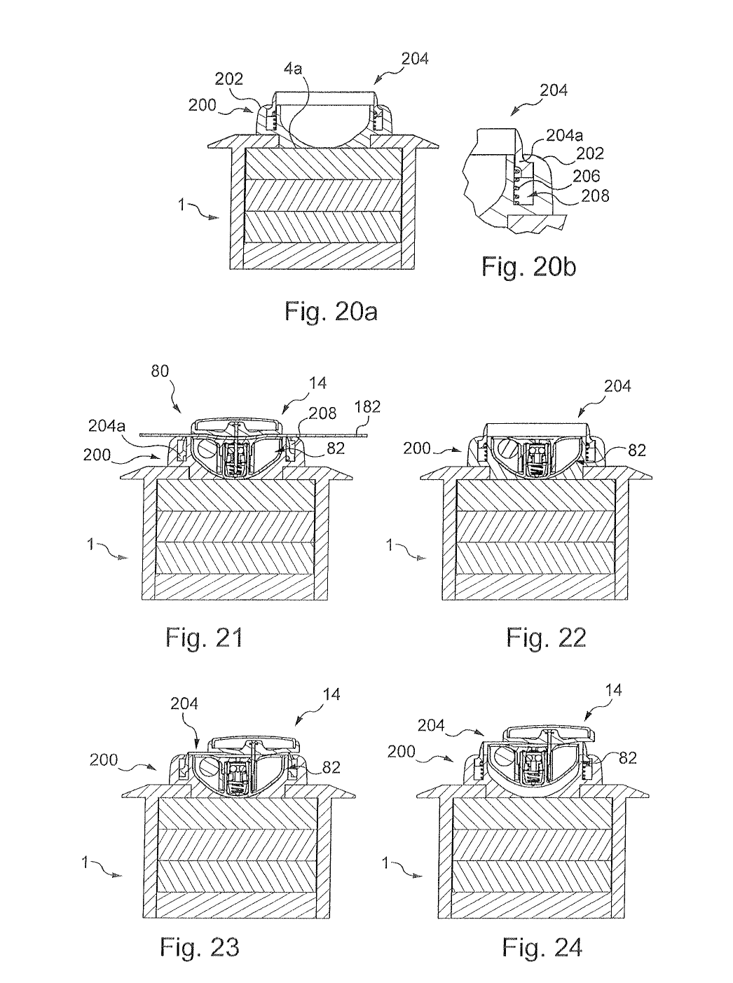

FIGS. 20a and 20b show a system including an unlocking device provided with mechanical stabilization means in accordance with a fifth embodiment of the invention with no protection system;

FIG. 21 shows the placement of a protection system attached to an article and positioned in the housing of the stabilization means from FIG. 20a;

FIG. 22 shows one of the parts of the protection system wedged in the bottom of the housing of the stabilization means following separation of the two parts of the system;

FIGS. 23 and 24 show the use of the other part of the protection system to extract from the housing the part of the system that is wedged therein.

A magnetic unlocking device represented in FIG. 1 and designated by the general reference 1, also known as a decoupler, is used to unlocking magnetically a system for protecting against theft an article, for example a commercial article. This system referenced 10 is also referred to as a security tag.

The unlocking device and the security tag form a magnetic unlocking system.

The security tag 10 will be described after the device 1.

The unlocking device 1 includes a casing 3 that contains inside it a plurality of permanent magnets 4, and 6 the north and south poles of which are diagrammatically represented by the symbols “+” and “−”, respectively.

The arrangement of these magnets makes it possible to create a vertical permanent magnetic field B as shown by the arrow in FIG. 1.

The casing 3 includes a wall surrounding all of the magnets 4 to 6 almost entirely with the exception of an open area at the top arranged in the central part of a horizontal upper wall 7 of the casing.

The open central area 8 is shown in FIG. 2, which is a plan view of the device 1 on its own.

The upper wall 7 includes an external peripheral part 7a forming a flange that is intended to be supported on the top of a horizontal plane that is not represented in the figure and is intended for the installation of the device 1, for example alongside a store checkout.

The wall 7 also includes an upper internal peripheral rim 7b over a part only of its height that surrounds the central area 8.

The device 1 includes an unlocking surface 4a accessible via the opening in the area 8 and that here corresponds to the top face of the top permanent magnet 4.

This unlocking surface is perpendicular to the axial direction of the magnetic field B (here coincident with the vertical direction).

The security tag 10 will now be described with reference to FIG. 1.

As represented diagrammatically in FIG. 1, the security tag 10 includes a first part including a head having a spike 16 intended to pass through the article (garment, etc.) or the packaging containing the article, for example of the blister pack type.

The head more particularly includes a first portion 18 having a plate general shape in the central part of which is mounted one end 16a of the spike that forms its head.

It will be noted that the central part of the plate 18 is thicker than the remainder in order to accommodate therein the head 16a of the spike.

The part forming the plate 18 has an annular rim 20 that extends in the opposite direction to the spike so as to form an internal housing 22 delimited partly by the back 18a of the plate and partly by the annular rim 20.

It will be noted that the part forming the plate 18 has a face 18b opposite the face 18a and from which the body of the spike 16 extends substantially perpendicularly.

A protection element 24 such as a cap closes the housing 22 and bears on the internal face of the annular rim 20, for example being inserted over a shoulder that is not shown formed on this face.

The housing 22 includes for example a printed patch visible from outside the head 14 by virtue of the optical properties (for example transparency) of the cap or window 24.

The security tag also includes a second part 30 having a body forming a casing which comprises two portions in the example shown in FIG. 1.

A first portion 32 is similar to a substantially plane plate having a first face 32a in which there is an orifice 32b passing through the thickness of the plate for insertion of the spike 16 in the usual locked assembled mode.

The second part 30 also includes a second portion 34 of convex general shape which here takes the form of a dome, for example, or a substantially hemispherical shape.

This second portion is in the hollow assembly in order to accommodate therein a certain number of elements and has in an equatorial plane an opening for the introduction of the elements into the body of the second part 30. Here the opening is blocked by the plate 32.

The second part 34 includes a central cavity 36 in which are disposed locking means that are intended to prevent withdrawal of the spike 16 when the latter is introduced through the insertion orifice 32b.

The locking means include one or more magnetic material elements accommodated in the central cavity 36 that cooperate with the inserted spike 16 in order to prevent its axial withdrawal.

In FIG. 1, the two parts 14 and 30 are represented in the locked position with a distance E between them. This distance is necessary for the presence of the article to be protected that is trapped between the two parts. For clarity, the article through which the spike 16 passes is not represented.

The locking means are ball-type locking means as represented in FIG. 1, for example.

Such means include for example a plurality of balls 35 placed in a funnel-shaped part 37 inside the cavity 36, in the same plane and with a central space between them to receive the spike 16.

The part 37 extends along a so-called funnel axis that for clarity is represented by the reference A1 on the right-hand side of FIG. 1.

The second portion 34 also includes at the periphery of the cavity 36 an annular chamber 40 in which there is arranged a member 42, or even a plurality of members, for example passive members, i.e. members each adapted to receive electromagnetic waves coming from a source external to the protection system 10.

Such a member may take the form of an LC-type resonant circuit, for example.

Alternatively, the casing may enclose one or more active members, i.e. members that are able to emit electromagnetic waves from the interior toward the exterior of the protection system.

It will be noted that such active or passive members are, for example, coils with ferrite with or without capacitor, LCR circuits, magnetic filaments, RFID-type circuits provided with an active or passive memory chip, etc. By the transmission of electromagnetic waves, such member(s) cooperate(s) with an external detection system, such as a gate or an antenna placed at an access point of the store in which the article(s) to be protected are on sale in order to trigger an alarm on detection of the protection system at the access point.

To clarify the description, only the member 42 is represented in FIG. 1. It is for example a ferrite core around which is wound a coil (L). A capacitor (LC) and possibly a resistor (LCR) may be added to it.

In a variant that is not represented, such passive or active members are placed in the first part 14 of the security tag.

The balls 35 are mounted on an amagnetic material support 38, which is mounted on amagnetic material elastic means, such as a spring 39. The elastic means 39 exert on the support 38 and therefore on the balls an axial force (in the direction A1) that tends to push them farther into the narrowest part of the funnel 37.

When the spike 16 is inserted in the space between the balls 35, the balls are locked in the convergent part of the funnel located near the plate 32.

Any attempt at axial withdrawal of the spike tends to force the balls farther into the convergent part of the funnel and therefore to immobilize the spike even more.

It will be noted that the balls 35 are metal balls and are more particularly made from a magnetic material, which makes it possible for an external magnetic field such as that generated by the magnets 4 to 6 of the device 1 to extract them from the convergent part of the funnel 37.

It will be noted that the ball-type locking means and the spike form a locking system of the security tag 10.

The unlocking of the locking means of the tag 10 is made possible if the funnel axis A1 (also referred to as the unlocking axis) is aligned with the axial direction of a magnetic field, namely the vertical magnetic field from FIG. 1.

Under these conditions, the magnetic field exerts on the balls 35 an axial attraction force that tends to compress the elastic means 39 (in the vertically downward direction), therefore lowering the support 38 and the balls bearing on the latter. The spike 16 is then released from the balls, which enables the axial withdrawal of the this spike and therefore the separation of the two parts of the badge and the release of the article trapped between them.

It will be noted that this unlocking is possible only if the funnel axis or unlocking axis A1 has the same geometrical or spatial orientation as the axis of the magnetic field generated by the magnet(s) of the device 1.

FIG. 1 shows the geometrical or spatial alignment of these axes.

FIG. 4 shows a situation in which the unlocking axis A1 is not parallel to the axis of the magnetic field B that is generated by the unlocking device 1.

In fact, the article to be protected, not represented in this figure but normally trapped between the two parts of the tag, conceals the unlocking surface 4a at the bottom of the area 8 from the sight of the employee of the store.

The position of the tag 10 on this surface 4a has been intentionally exaggerated in FIG. 4 in order to make it clear that if the orientation of the unlocking axis A1 does not correspond to that of the magnetic field B unlocking cannot take place.

The employee may waste a lot of time before finding the correct geometrical orientation of the tag.

A high magnetic field intensity of the order of 16000 Gauss or more further complicates this task.

It will be noted that the security tag 10 that has just been described is not a prior art tag; only the unlocking device 1 from FIG. 4 is part of the prior art.

To solve the problem explained above, the device 1 includes means for receiving and mechanically stabilizing the tag in order to confer on it a predetermined geometrical or spatial orientation. Here, this orientation is that consisting in aligning the unlocking axis A1 with the axis of the magnetic field generated by the magnet(s) of the device 1, i.e. disposing the axis A1 perpendicularly to the surface 4a.

If an employee of a store wishes to release the article trapped between the two parts of the security tag, they position the second bottom part 30 of the tag above the receiving and mechanical stabilization means 50 equipping the device 1.

The means 50 include a central housing to receive at least a part of the tag. The magnetic field then attracts the second part 30 directly into the housing where it locks automatically in the correct position/orientation.

The employee may for example touch the housing with a finger to introduce into it, for example, the lower part 30 of the badge as represented in FIGS. 1 and 3.

However, the intensity of the magnetic field is such (for example approximately 16000 Gauss) that on placing the tag above the stabilization means, the tag is attracted magnetically and therefore automatically into the housing.

The stabilization means 50 are therefore configured to confer on the tag received in their housing 52 the required predetermined orientation.

It will however be noted that this housing has a shape complementary to the exterior shape of the part of the badge intended to be received in said housing.

In the example shown in FIG. 1, the second part 30 of the tag has a rounded convex shape, for example a dome shape, and the housing 52 therefore has a concave complementary shape (bowl or cup shape with the opening oriented upwards) espousing the convex shape of the part 30.

As represented in FIG. 5 showing the device 1 fitted with the stabilization means 50 with no security tag, the housing 52 has a bottom 52a facing the unlocking surface 4a and, on the side opposite the bottom, an opening 52b (here circular) via which the security tag can be introduced into the housing.

The opening 52b and the bottom 52a are arranged opposite each other in an axial direction Z perpendicular to the unlocking surface 4a and therefore parallel to the axis of the magnetic field in the vicinity of this surface.

As represented in FIG. 5, the stabilization means 50 include an annular wall 54 that flanks the central housing, this annular wall extending in the axial direction Z.

The stabilization means more particularly take the form of a stabilization body that includes a base or plinth 56 occupying all of the central area 8 (FIG. 2) left free inside the supporting wall 7.

The annular wall 54 extends outward from the base 56 in a radial first direction so as to form a shoulder 54a that engages over the upper rim 7b of the wall 7 and in a perpendicular axial second direction (axis Z) that extends the stabilizer body in the direction away from the base 56 and the unlocking surface 4a. The height of the housing is therefore defined by the distance between the upper free edge 54b of the wall and the bottom 52a.

In this embodiment, the stabilization means 50 are mounted on the device 1 in a fixed manner.

However, in a variant, the stabilization means may be arranged on the unlocking surface of the unlocking device in a removable manner.

As shown in FIG. 3, the wall 54 that surrounds the housing 52 in which the tag 10 is accommodated (as in a nest) is not uninterrupted but instead features localized notches such as that referenced 58.

In this embodiment, the stabilizer includes two notches diametrically opposite each other in the annular wall 54, therefore conferring on the stabilizer an undulating shape consisting of an alternation of recesses (notches) and bosses.

It will be noted that the notches may be more or less pronounced.

For example, in the extreme situation the notches extend the full height of the annular wall and therefore form two separate wall parts (ring segments).

Alternatively, more than two notches may be envisaged.

In the embodiment shown in FIGS. 1 to 3 and 5 the annular wall 54 has a height less than that of the part of the security tag that includes the ball-type locking means and that is intended to be positioned in the housing 52 with a view to magnetic unlocking and separation of the two parts.

If the wall 54 were uninterrupted over the whole of its perimeter it would be very difficult for a store employee to extract the part 30 of the security tag from the housing once the part 14 has been removed.

However, thanks to the notches 58 the employee can tilt the part 30 in its housing on one of the sides including a notch.

Accordingly, by pressing with the finger on the part 30 at one of the places where there is located a notch 58, this area of the part 30 will be lowered while at the level of the opposite notch the opposite area of the part 30 will be raised, thereby enabling the employee to grip the body of the part 30 easily.

Moreover, the bottom 52a of the housing 52 is pierced, which makes it possible to favor positioning the second part 30 of the security tag as close as possible to the permanent magnets.

Here, the pierced bottom enables the second part 30 represented in FIG. 1 to come into contact with the magnetic unlocking surface 4a and therefore to benefit more from the action of the magnetic field for unlocking.

FIGS. 6 and 7a-b show a second embodiment in which the security tag differs from that from FIGS. 1, 3 and 4.

The references of the elements already described with reference to FIGS. 1, 3 and 4 and that are found again here are retained.

The security tag 80 from FIG. 6 differs from the tag 10 in the presence, in the second part 82 of the tag (the first part 14 is unchanged) of an opening that is at a distance from the orifice for inserting the spike for locking the two parts.

The second part 82 of the security tag 80 includes a plate 84 similar to the plate 32 from FIG. 1 but which differs from the latter by the presence of the opening 86 separate from the insertion orifice 32b and eccentric relative to the latter.

This opening passes through the thickness of the plate and is parallel to the insertion orifice 32b.

The opening 86 is provided for temporarily assembling or coupling the first part 14 and the second part 82 without engaging the mechanism for locking the two parts.

This temporary assembly then enables a user to separate the two parts from each other by exerting a simple separation force when holding each of the parts in one of their hands, without needing any tool.

As represented in FIG. 6, the spike 16 is introduced axially into the opening 86 and extends inside a hollow part provided in the annular chamber 88 surrounding the central cavity 36.

The spike 16 is engaged over the greater part of its length in order for the free end 16b to be disposed inside the hollow part of the casing.

The latter includes a central wall 90 that extends from the wall 34 of said casing that is opposite the plate 84.

This peripheral wall 90 surrounds the central cavity 36.

A member internal to the casing is provided inside the latter (in the annular chamber 88) to exert on the spike 16 a lateral mechanical force tending to prevent too easy axial withdrawal of this spike.

This member may take different forms inside the casing such as a tongue extending from one of the walls of the casing and the elasticity of which enables it to immobilize the spike temporarily.

However, in the FIG. 6 embodiment another type of internal member is provided to cooperate with the spike 16 in order to prevent its untimely withdrawal.

Here this internal member constitutes an attached part, which has the advantage of introducing very few modifications when manufacturing the casing.

On the internal side of the casing of the second part 82, the plate 84 includes in its central part a projecting part 84a of cylindrical general shape surrounding over virtually all of its internal circumference the cylindrical wall 90 delimiting the central cavity 36.

The projecting part 84a forms a kind of hub around the cylindrical wall 90 with the exception of the area located in the vicinity of (in vertical alignment with) the opening 86 which is interrupted locally to enable arrangement of the spike 16 against the exterior face of the wall 84a.

An internal member 92 in the form of an annular ring (or washer) surrounds the hub 84a and is force-fitted around the latter before the plate 84 is installed in position to close the casing like a lid.

This member is for example made from an elastic material such as a rubber.

The spike 16 is then inserted in the opening 86 after which it slides where an area of the hub 84a is removed (groove), between the ring 92 and the wall 90.

The spike 16 is then force-fitted into this hollow part located inside the second part 82 and the dimensions of which are sufficiently close to those of the spike to prevent too easy axial withdrawal.

In this position the first part 14 is offset transversely/laterally relative to the second part 82, relative to a centered axial configuration such as that of FIG. 1 (the spike 16 is inserted into the central insertion orifice).

This position of immobilization and temporary assembly makes it possible to move the two parts of the security tag 80 jointly with no risk of disassembling them through inadvertence or clumsiness.

When the security tag 80 is placed in the stabilization means 50 from FIGS. 1, 3 and 5 the magnetic unlocking may be effected as explained above. The two parts 14 and 82 of the tag 80 can then be separated from each other, thereby releasing the article trapped between them.

In order to facilitate the removal of the second part 82 of the tag that remains in the housing 52 of the stabilization means 50, the eccentric opening 86 of the tag from FIG. 6 is used to receive the spike 16 of the first part 14 and thus to assemble or couple temporarily the two parts as represented in FIGS. 6 and 7a.

In FIG. 7a, the first part 14 has been repositioned above the second part 82 which is engaged in the mechanical stabilization means 50, like a lid that is eccentric or offset transversely/laterally.

As represented in FIG. 7a, the user (for example the employee of the store) then exerts on the periphery of the first part 14 an eccentric downward force F, this force being applied above one of the notches 58.

By virtue of the action of this force the tag 80 tilts and is then inclined as shown in FIG. 7b, therefore enabling a larger part of the badge to emerge at the level of the other, opposite notch 58. This facilitates gripping of the tag by the fingers of the user.

In particular, by proceeding in this way the user's finger can have access to the lower area of the second part 82 that previously was facing the bottom of the housing.

The user's task in withdrawing the second part 82 of the badge is therefore greatly simplified.

It will be noted that when the mechanical stabilization means are not removable they may form an integral part of the casing of the device 1 and therefore be produced in one piece with the horizontal upper wall 7.

FIGS. 8 and 9 show two variant embodiments of a security tag cooperating with the unlocking device 1 provided with mechanical stabilization means 50.

In FIG. 8, the stabilization means cannot be seen in that the tag 100 is positioned over them.

More particularly, the tag 100 includes a first part identical to the first part 14 bearing the spike 16 and a second part 102 that is placed on the stabilization means, notably in the internal housing provided in them.

The second part 102 includes a plate 104 closing the opening allowing access to the interior of the casing constituting the second part 102 and in which are notably arranged the locking means of the two parts and the member(s) adapted to receive electromagnetic waves from a source external to the tag or to emit such waves toward the exterior.

In the plate 104 are formed a central orifice 104a for the insertion of the spike of the first part 14 (for locking purposes) and, around the latter, at a distance therefrom, a plurality of openings 104b-f which, like the opening 86 in FIG. 6, are intended to receive the spike in order to couple the two parts of the tag temporarily.

The means for fixing or immobilizing the spike inside the casing of the second part 102 may be similar to that described with reference to FIG. 6 or different.

The plurality of openings 104b-f makes it possible to facilitate the positioning of the spike compared to a situation in which the plate includes only one opening separate from the insertion orifice.

It will be noted that when the spike is inserted in one of these openings the system coupled in this way has the same advantages as those described with reference to FIGS. 6, 7a and 7b.

FIG. 9 shows another variant embodiment in which the security tag 110 comprises the same first part 14 and a second part 112 that is represented in part inside the housing 52 defined by the mechanical stabilization means 50.

The second part 112 is therefore held in position by the two annular wall parts 54 that surround it in order to confer on it the orientation required for unlocking the two parts.

The second part 112 includes, in its upper part, a plate 114 analogous to the plate 104 from FIG. 8 and providing the same closing function as the latter.

The plate 114 has in its central part an insertion orifice 114a for the axial insertion of the spike 16.

The plate 114 also includes in a peripheral area forming a belt around the insertion orifice 114a a plurality of openings analogous to the openings 104b-f from FIG. 8 and of which only two openings 114a and 114b are represented in FIG. 9.

More particularly, the peripheral belt surrounding the insertion orifice 114a is structured in such a manner as to feature a succession of hollows and projections, the openings 104b-f being positioned at the bottom of respective hollows.

This peripheral area with a relief or height difference constitutes an aid to positioning the spike 16 of the first part 14 in one of the peripheral openings with a view to temporary coupling to each other or assembly of the two parts.

This variant also makes it possible to obtain the same advantages as those described with reference to FIGS. 7a and 7b for the extraction of the security tag out of the housing of the receiving and mechanical stabilization means.

FIG. 10 represents another embodiment of a device for unlocking a security tag.

The unlocking device or decoupler 120 has the same structure as described with reference to FIG. 1 with the exception of its upper part for accommodating means for mechanical stabilization of a security tag.

In particular, the device 120 includes a horizontal top wall provided at its periphery with a flange 122a and the central part 122b of which is open like the wall 7 from FIGS. 1 and 2.

The open part defines an opening of substantially cylindrical shape the height of which corresponds to the height of the wall 122 relative to the unlocking surface 4a.

Two diametrically opposite radial notches 122c, 122d are produced in the wall 122 at the periphery of the opening 122b.

The mechanical stabilization means take the form of a stabilizer body 130 shown in FIG. 11 that is intended to equip the device 120 in a removable manner (FIG. 12).

The stabilizer body 130 includes, just like the body of the stabilization means 50, an annular wall 132 interrupted locally in two diametrically opposite peripheral areas in order to form two notches 134.

These two annular wall parts 132 define between them a housing 136 to receive and stabilize a security tag 140 (FIG. 12) analogous to the security tags described above.

The stabilizer body 130 has at its base 138 attachment members 139 intended to engage in the notches 122c and 122d from FIG. 10.

The body 130 includes two diametrically opposite attachment members 139 of which only one can be seen in FIG. 11.

These attachment members project relative to the base 138 and for example take the form of pegs or lugs inserted in respective notches 122c and 122d.

It will be noted that the open central part 122b of the wall 122 may extend radially a short distance under the latter in order to form a rim or shoulder 122e.

Accordingly, when the stabilizer body is placed on the device from FIG. 10 the male members 139 are inserted in the female members or notches 122c and 122d. The body 130 is then pushed into the open central part until it comes into contact with the surface 4a and, by virtue of a movement in rotation of the body, the attachment members 139 are immobilized under the rim 122e of the wall 122.

The mounting system therefore constitutes a bayonet system as notably found on cameras for attaching lenses.

It will be noted that one or more abutments may be provided under the rim to limit the rotation of the body 130.

In this way the stabilizer body is mounted in a removable manner on the unlocking device 120 as explained above.

The stabilizer body provides the same advantages as described with reference to the preceding figures.

FIGS. 13 to 15 show a variant embodiment of a stabilizer body removable from the unlocking device 120.

As represented in FIG. 13, the stabilizer body 150 is formed by an uninterrupted annular wall 152 having an upwardly oriented flared general shape, for example the general shape of a cup.

The body also includes a base 153 having at its periphery two attachment members 139 for mounting said body on the device 120 in exactly the same way as described with reference to FIGS. 10 to 12.

The base 153 is centrally pierced so that the body 154a of the housing 154 defined by the flared annular wall 152 is pierced and in direct contact with the unlocking surface 4a. The bottom of the housing 136 from FIG. 11 is also pierced for the same reasons.

FIG. 14 shows the stabilizer body 150 installed on the device 120.

FIG. 15 represents very diagrammatically in axial section a security tag 160 positioned in the housing 154 and espousing the shape of the wall 152.

The security tag 160 is also in two parts, a top part 160a and a bottom part 160b that are locked together by ball-type locking means (not shown) as described above.

The ball-type locking means are in the bottom part 160b whereas the spike (not shown) is in the part 160a.

This tag has substantially the shape of a rugby ball in cross section.

This type of security tag is used to protect textile articles, for example.

FIG. 16 shows another embodiment of the receiving and mechanical stabilization means.

In this other embodiment the device 1 described with reference to FIGS. 1 to 5 is equipped with mechanical stabilization means 170 the body of which includes an uninterrupted annular wall 172 that has an axial dimension or height, measured perpendicularly to the unlocking surface 4a, substantially equal to the axial dimension or height of the second part 82 of the security tag 80.

This axial dimension or height of the second part 82 is measured along the unlocking axis A1 or funnel axis.

As shown in FIG. 16, when the first part 80 of the security tag has been separated from the second part 82, the latter remains inside the central housing internal to the annular wall 172.

To the extent that the lower part 82 of the security tag completely fills the space 190 (housing) internal to the wall 172 and is flush with this wall 172, the user (store employee) has no possibility of gripping with their fingers to grasp this part.

Thanks to the presence of the opening 86 of the security tag 80 from FIG. 6, the first part 14 of the latter can be inserted in this opening as shown in FIG. 17 (offset extraction position).

By forcing this spike through this opening and inside the casing of the part 82 the two parts of the tag are therefore coupled temporarily.

It then suffices for the user to grasp the tag by the first part 14 for the second part 82 that is temporarily fixed to it to follow it and therefore to be extracted from the housing of the stabilization means.

FIG. 18 shows another embodiment of the mechanical stabilization means of a security tag mounted on the unlocking device 1.

The security tag is that shown in FIG. 6 which includes the first part 14 and the second part 82.

In FIG. 18 the security tag 80 is shown pushed inside the mechanical stabilization means 180 equipping the unlocking device 1.

The two parts 14 and 82 of the security tag are locked to each other as described above and grip between them an article to be protected which here is represented by a textile article 182 (garment, etc.).

The spike of the security tag passes through the thickness of the textile, thus trapping it between the two parts of the tag.

The body of the mechanical stabilization means 180 includes an uninterrupted annular wall that includes a first part similar to the wall 172 from FIGS. 16 and 17 in that it is the same height as that of the second part 82 of the tag.

However, the wall 184 is wider in the radial direction than the wall 172.

The annular wall 184 has at its upper free edge a peripheral rim 186 thinner than the wall 184 in order to form a radial step or shoulder extending outward relative to the annular wall in order to raise the latter.

The radial step or shoulder delimited by the peripheral rim 186 therefore makes it possible to provide between the security tag 80 and the peripheral rim 186 an interior peripheral space to accommodate the article 182.

This arrangement is useful if the article to be protected is deformable and can therefore be folded to follow the security tag into the internal space 192 defined by the raised wall of the stabilizer body.

As shown in FIG. 18, the annular wall of the stabilizer body is raised relative to that from FIGS. 16 and 17 so that the height of this wall is substantially equal to that of the security tag 80 when the latter is trapping an article to be protected or its packaging.

Once the security tag has been placed in the housing of the stabilizer body, it then automatically adapts the geometrical orientation required for the magnetic unlocking to occur, thereby releasing the first part 14 which the employee of the store can then remove.

In this way the article 182 can be handed to the customer of the store who purchased it.

However, when the first part 14 and the article have been removed the second part 82 of the tag remains trapped inside the central housing of the stabilizer body as shown in FIG. 19.

Just as in the embodiment shown in FIGS. 16 and 17, the presence of the opening 86 makes it possible to remove the second part 82 from its housing.

It will be noted that the security tags of the variants from FIGS. 8 and 9 can also be used for the embodiments of the FIGS. 16 to 19.

FIGS. 20a and 20b show another embodiment of means for mechanical stabilization of a security tag.

Mechanical stabilization means 200 are mounted on the magnetic unlocking device 1 in a removable or non-removable manner.

These means include a body that has a wall 202 thicker than but substantially the same height as the wall 172 from FIG. 16.

The annular wall 202 has at its upper free edge a protection ring 204 that is mounted on elastic means 206 such as a spring.

As shown in FIGS. 20a and 20b (partial view to a larger scale) the elastic means are arranged in an annular groove 208 made within the thickness of the wall 202 in order to accommodate therein the elastic means 206.

The ring 204 includes at its external periphery a bottom rim 204a that is inserted in the groove 208 and cooperates with the elastic means 206.

With no additional mechanism (motor, etc.), the ring 204 is able to move axially (here vertically) relative to the fixed annular wall between a first extended high position, shown in FIG. 20b (the ring extends axially the annular wall 202), and a second retracted low position, shown in FIG. 21 to be described hereinafter. The axis along which the protection ring moves is perpendicular to the unlocking surface 4a.

The elastic means exert a permanent axial force on the peripheral rim 204a that tends to push the latter into abutting engagement in the upper part of the groove, thus retaining the ring 204 in its extended high position in which it raises the annular wall 202.

In FIG. 20a no security tag is installed in the housing of the stabilizer body.

FIG. 21 shows the placing in the housing of the stabilizer body of the security tag 80 the two parts 14 and 82 of which are locked to each other and grip between them an article 182 such as a textile article.

When the employee of the store positions the second part 82 of the tag in the internal housing of the stabilizer body, the presence of the article to be protected between the two parts exerts a pressure on the ring 204 tending to compensate the force exerted by the elastic means 206.

By pressing manually on the ring in this way, the latter adopts a low position shown in FIG. 21 in which the rim 204a is at the bottom of the groove 208.

The security tag therefore having the required spatial orientation (unlocking axis and axis of the magnetic field created by the device 1 parallel), the magnetic unlocking of the two parts 14 and 82 takes place and the employee can remove the first part 14 to release the article 182.

The ring 204 is then no longer subjected to any pressure and, pushed by the elastic means 206, rises naturally into its high position from FIG. 20a (FIG. 22).

The second part 82 of the security tag nevertheless remains trapped in the housing of the stabilizer body and concealed by the ring, which makes extraction even more difficult than in FIGS. 16 and 17.

In an analogous fashion to what has been described with reference to FIGS. 17 and 19, the first part 14 of the security tag is used to extract the second part 82 stuck in the housing of the stabilizer body.

As shown in FIGS. 23 and 24, the additional opening is used to couple the two parts 14 and 82 temporarily.

When the first part 14 is moved near the second part 82 to insert the spike therein, the first part 14 comes into contact with the annular protection rim 204 and lowers the latter to its FIG. 21 retracted low position.

FIG. 23 shows the ring in the low position when the spike of the first part 14 is inserted inside the second part 82 and the laterally offset first part 14 is resting on the annular ring 204.

It then suffices for the employee to grasp the first part 14 and to lift it so that the second part 82 is extracted vertically from the housing as shown in FIG. 24.

During this movement, the first part 14 ceases to bear on the annular ring and the latter then returns naturally to its extended high position, as already described with reference to FIG. 20a.

1. A magnetic unlocking system, characterized in that it includes:
a system (10) protecting against the theft of a packaged or unpackaged article, the system comprising two parts (14, 30) locked to each other by axial insertion of a spike of a first part in an orifice of a second part that includes means for locking the inserted spike, the second part having at least one opening separate from the orifice for receiving the spike of the first part and retaining it there so as to be able to raise the two parts of the system holding only the first part,
a device for magnetically unlocking the protection system (10) that includes:
a casing (3) enclosing at least one permanent magnet (4, 5, 6),
an unlocking surface (4a) provided with means (50) for reception and mechanical stabilization of the system (10), said means being designed to receive at least one part of the system (10) and to stabilize it in a predetermined orientation, said predetermined orientation enabling the magnetic field that is generated by said at least one permanent magnet, perpendicularly to the unlocking surface, to unlock magnetically the two parts of the protection system.

2. The system as claimed in claim 1, characterized in that the receiving and mechanical stabilization means define a central housing (52) to receive at least one part of the protection system, the shape of said housing being substantially complementary to that of said at least part of the protection system.

3. The system as claimed in claim 2, characterized in that the housing has a bottom (52a) facing the unlocking surface and an opening (52b) on the side opposite the bottom, the bottom and the opening being disposed opposite each other in an axial direction (Z) perpendicular to the magnetic unlocking surface (4a).

4. The system as claimed in claim 2, characterized in that the receiving and stabilization means include at least one annular wall (54) at least partly delimiting the central housing.

5. The system as claimed in claim 4, characterized in that said at least one annular wall has an axial dimension referred to as its height that extends in an axial direction perpendicular to the magnetic unlocking surface.

6. The system as claimed in claim 5, characterized in that said height is substantially equal to the dimension or height of said at least one part of the protection system that is intended to be inserted in the housing.

7. The system as claimed in claim 4, characterized in that notches (58) are produced in said at least one annular wall so as to interrupt the latter locally or to reduce locally the axial dimension referred to as the height of said at least one annular wall, the axial dimension being perpendicular to the horizontal magnetic unlocking surface (4a).

8. The system as claimed in claim 7, characterized in that two diametrically opposite notches (58) are produced in said at least one annular wall.

9. The system as claimed in claim 4, characterized in that the receiving and stabilization means include an uninterrupted annular wall surrounding the central housing.

10. The system as claimed in claim 9, characterized in that the uninterrupted annular wall (184) has at its upper free edge a peripheral rim (186) forming an internal radial step with respect to said annular wall in order to raise it.

11. The system as claimed in claim 10, characterized in that the uninterrupted annular wall (184) having the raising peripheral rim (186) has an axial dimension referred to as its height that extends in an axial direction perpendicular to the horizontal magnetic unlocking surface.

12. The system as claimed in claim 11, characterized in that said height is substantially equal to the dimension or height of the part of the protection system that is intended to be inserted in the central housing.

13. The system as claimed in claim 9, characterized in that the uninterrupted annular wall (202) has at its upper free edge a protection ring (204) mounted on elastic means (206) and forming a peripheral rim mobile axially between a first extended high position raising the fixed annular wall and a second retracted low position relative to the fixed annular wall, the elastic means exerting a permanent axial force on the protection ring that tends to retain it in the extended high position.

14. The system as claimed in claim 13, characterized in that the uninterrupted annular wall (202) having the protection ring (204) has an axial dimension referred to as its height that extends in an axial direction perpendicular to the horizontal unlocking surface.

15. The system as claimed in claim 14, characterized in that said height is substantially equal to the dimension or height of the whole protection system that is intended to be inserted in the central housing.

16. The system as claimed in claim 2, characterized in that the central housing has a bottom that is pierced and opens directly on the magnetic unlocking surface.

17. The system as claimed in claim 1, characterized in that the receiving and mechanical stabilization means are mounted on the unlocking surface in a removable or fixed manner.

18. The system as claimed in claim 1, characterized in that the receiving and mechanical stabilization means are formed in one piece.

19. The device as claimed in claim 1, characterized in that the protection system includes a system for locking the two parts including the locking means that are unlockable magnetically by movement of said means along a so-called unlocking axis by the action of a magnetic field with the same axis.

20. The system as claimed in claim 19, characterized in that the receiving and mechanical stabilization means are configured to orient the unlocking axis of the locking means in a direction parallel to the axis of the magnetic field generated by said at least one permanent magnet of the magnetic unlocking device.

21. The system as claimed in claim 1, characterized in that the locking means of the second part include one or more magnetic material elements cooperating with the inserted spike in order to prevent the axial withdrawal thereof.

22. The system as claimed in claim 21, characterized in that the magnetic material elements are balls surrounding the spike and disposed in the same plane inside a funnel-shaped part that extends along a so-called funnel axis, the balls being mounted on amagnetic material elastic means that tend to push said balls toward the narrowest part of the funnel-shaped part along said funnel axis.

23. The system as claimed in claim 21, characterized in that the second part includes a first portion including the orifice for the axial insertion of the spike of the first part in said second part and a second portion in which the inserted spike extends at least in part and is locked.

24. The system as claimed in claim 23, characterized in that the first portion includes said at least one opening separate from the orifice for inserting the spike of the first part in a hollow portion of the second portion, the hollow portion being designed to receive the spike and to retain it in an unlocked so-called assembly position of the two parts of the protection system, this position being such that a user is able to separate the two parts from each other without tools.

25. The system as claimed in claim 1, characterized in that the external surface of said at least one part of the protection system is convex and smooth.

26. The system as claimed in claim 3, characterized in that the central housing has a cup general shape having an internal surface that is smooth.

27. A method of magnetically unlocking a system for protecting a packaged or unpackaged article against theft, characterized in that the protection system comprises two parts (14, 30) locked to each other by axial insertion of a spike of a first part in an orifice of a second part that includes means for locking the inserted spike, the second part including at least one opening separate from the orifice for receiving the spike of the first part and retaining it there, the method including the following steps:
positioning at least one part of the protection system attached to the article on an unlocking surface of a magnetic unlocking device that includes at least one permanent magnet,
mechanical stabilization of said at least part of the system in a predetermined orientation, said predetermined orientation enabling the magnetic field that is generated by said at least one permanent magnet, perpendicularly to the unlocking surface, to unlock magnetically the two parts of the protection system,
magnetic unlocking of the protection system,
separation of the two parts of the protection system by raising the first part, the second part remaining in a mechanically stabilized position,
removing the article.

28. The method as claimed in claim 27, characterized in that the second part is retained in a mechanically stabilized position in a housing the shape of which is substantially complementary to the exterior shape of said second part, thereby rendering its extraction difficult.

29. The method as claimed in claim 27, characterized in that it further includes the following steps:
axial insertion of the spike of the first part in said at least one opening of the mechanically stabilized second part until an axial position of the inserted spike is reached in which the two parts are assembled mechanically to each other in an unlocked manner,
grasping the first part and raising it, therefore entraining in this movement the second part assembled with the first part.

30. The method as claimed in claim 27, characterized in that when the spike of the first part is inserted axially in said at least one opening, the first and second parts are offset transversely relative to each other with respect to a so-called axial locking position in which the two parts are axially aligned with each other when the spike is inserted axially in the orifice.

31. A device for magnetically unlocking a system for protecting a packaged or unpackaged article against theft, the device including a casing containing at least one permanent magnet and an unlocking surface intended to receive an anti-theft protection system in order to proceed to the magnetic unlocking of said protection system, characterized in that the device includes on the unlocking surface mechanical stabilization means intended to stabilize the protection assembly in a predetermined orientation, said predetermined orientation enabling the magnetic field that is generated by said at least one permanent magnet, perpendicularly to the unlocking surface, to unlock magnetically the protection system, the stabilization means including at least one annular wall (54) that at least partly delimits a central housing intended to receive at least one part of the protection system, notches (58) being produced in said at least one annular wall so as to interrupt it locally or to reduce locally the axial dimension, referred to as the height, of said at least one annular wall, the axial dimension being perpendicular to the magnetic unlocking surface (4a).

32. The device as claimed in claim 31, characterized in that the central housing has a bottom that is pierced and opens directly onto the horizontal magnetic unlocking surface (4a).

33. The device as claimed in claim 31, characterized in that the central housing has a cup general shape having an internal surface that is smooth.

34. The device as claimed in claim 31, characterized in that the stabilization means are formed in one part.

35. The device as claimed in claim 34, characterized in that the stabilization part is mounted on the magnetic unlocking surface in removable or fixed manner.

36. A device (1) for magnetically unlocking a system for protecting a packaged or unpackaged article against theft, the device including a casing (3) containing at least one permanent magnet (4, 5, 6) and an unlocking surface (4a) intended to receive an anti-theft protection system (10) in order to proceed to the magnetic unlocking of said protection system, characterized in that the device includes on the unlocking surface mechanical stabilization means (50) intended to stabilize the protection system in a predetermined orientation, said predetermined orientation enabling the magnetic field that is generated by said at least one permanent magnet, perpendicularly to the horizontal unlocking surface (4a), to unlock magnetically the protection system, the stabilization means being formed of a part including at least one uninterrupted annular wall (184; 202) that delimits a central housing intended to receive at least one part of the protection system.

37. The device as claimed in claim 36, characterized in that said at least one uninterrupted annular wall (184) has at its upper free edge a peripheral rim (186) forming an internal radial step with respect to said at least one annular wall in order to raise it.

38. The device as claimed in claim 37, characterized in that said at least one uninterrupted annular wall having the raising peripheral rim (186) has an axial dimension referred to as its height that extends in an axial direction perpendicular to the magnetic unlocking surface (4a).

39. The device as claimed in claim 36, characterized in that said at least one uninterrupted annular wall (202) has at its upper free edge a protection ring (204) mounted on elastic means (206) and forming a peripheral rim mobile axially between a first extended high position raising said at least one fixed annular wall and a second retracted low position relative to said at least one fixed annular wall, the elastic means exerting a permanent axial force on the protection ring that tends to retain it in the extended high position.

40. The device as claimed in claim 39, characterized in that said at least one uninterrupted annular wall (202) provided with the protection ring (204) has an axial dimension referred to as its height that extends in an axial direction perpendicular to the magnetic unlocking surface (4a).

41. The device as claimed in claim 36, characterized in that the central housing has a bottom that is pierced and opens directly onto the magnetic unlocking surface (4a).

42. The device as claimed in claim 36, characterized in that the central housing has a cup general shape having an internal surface that is smooth.

43. The device as claimed in claim 36, characterized in that the stabilization part is mounted on the magnetic unlocking surface in removable or fixed manner.
